(19) United States
(12) Patent Application Publication
(10) Pub. No.: US 2008/0314970 A1
(43) Pub. Date: Dec. 25, 2008

(54) KEYPAD SYSTEM AND METHOD

(76) Inventor: CAROL A. RODRIGUEZ, Fullerton, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/765,363

(22) Filed: Jun. 19, 2007

(51) Int. Cl. G07F 19/00

(52) U.S. Cl. 235/379

(57) ABSTRACT

A keypad system and method includes a keypad disposable in a position accessible by a user and a supply of security devices disposable proximate the keypad and accessible by the user. Each of the security devices includes a card having a finger opening sized for receiving a user's finger therethrough.

The present invention is generally related to automated teller machines (ATMs) and is more particularly directed to a system and method for protecting the personal identification number (PIN) or password of a user.

ATMs have become ubiquitous and are commonly used to carry out transactions such as depositing cash, checking account balances, paying bills and/or receiving deposits from users.

With the constant threat of hackers, piracy, identity theft and so forth a person can never be too cautious during operation of an ATM machine.

While a number of strategies are utilized by wrongdoers to obtain PINs, a simple and effective method has been to observe an ATM user's finger movements in order to learn the PIN.

The present invention provides for a keypad system which prevents direct unwanted observation of a user's finger movement.

### SUMMARY OF THE INVENTION

A keypad system in accordance with the present invention generally includes a keypad which is disposable in a position accessible by a user along with a supply of security devices disposable proximate the keypad and accessible by the user. Each of the security devices includes a card having a finger opening sized for receiving a user's fingertip therethrough.

More particularly, the card may include an iris having radially separated tabs which provide a means for temporarily supporting the card on the user's finger proximate the fingertip. An outer perimeter of the tabs defines the finger opening through the card.

Further features of the invention include visible indicia disposed on each card for conveying advertisement and/or instruction for use of the card and, in addition, each card preferably has overall dimensions preventing observation of the keypad by another person spaced apart from the user and the keypad.

The present invention also is specifically directed to a security shield for use with the keypad with the security shield comprising a card having a finger opening sized for receiving a user's finger along with radial tabs closing the finger opening and separatable by the finger tip for supporting the shield on the user's finger proximate the user's fingertip.

In addition, the present invention is directed to a method for enabling secure operation of a keypad with the method including providing a security device to users of the keypad with the security device including a card having a finger opening therethrough sized for receiving a user's fingertip. The method encompasses instructing the user to insert the fingertip through the finger opening and operating the keypad with the inserted fingertip. Further instruction may be provided with regard to instructing the user to position the card relative to the user's finger and hand in order to enable viewing of the keypad by the user and shielding the keypad from view of another person spaced apart from the user and the keypad.

### BRIEF DESCRIPTION OF THE DRAWINGS

The advantages and features of the present invention will be better understood by the following description when considered in conjunction with the accompanying drawings, in which:

FIG. 1 is a perspective view of the keypad system in accordance with the present invention and also illustrates the method in accordance with the present invention, a keypad and a supply of security devices being shown;

FIG. 2 is an illustration of prevention of observation of the keypad by another person spaced apart from the user; and

FIG. 3 is a plan view of the security device, or security shield, in accordance with the present invention.

### DETAILED DESCRIPTION

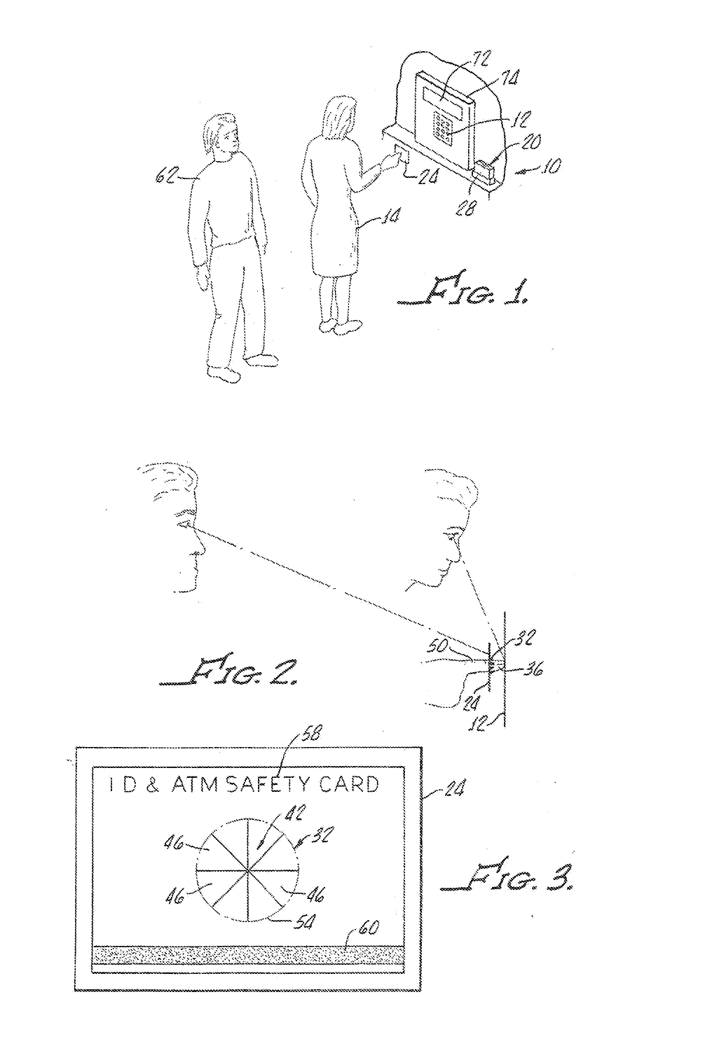

With reference to FIG. 1, there is shown a keypad system 10 which generally includes a keypad 12 disposable in a position accessible by a user 14. The keypad 12 may be of any conventional type and operate as is well known in the art.

The system 10 further includes a supply 20 of cards, or security shields, 24 one being shown separately in FIGS. 2-3. A holder 28 may be provided for the cards for enabling disposition proximate the keypad 12 and accessible by the user 14.

Each card 24 includes a finger opening 32 therethrough which is sized for receiving a user's fingertip 36 therethrough, as best illustrated in FIG. 2. An iris 42 including a plurality of radially separatable tabs 46 provides a means for temporarily supporting the card on the user's finger 50 proximate the user's fingertip 36, as also illustrated in FIG. 2.

As shown illustrated in FIG. 3, an outer perimeter 54 of the tabs 46 defines the finger opening 32.

While illustrating the means for temporarily supporting the card 24 on a user's finger 50 is shown as an iris 42 with tabs 46, other means are also contemplated such as, for example, separatable strips, elastic elements, or any other configuration enabling the user's fingertip 36 to be inserted through the card 24 while at the same time stabilizing the card 24 on the user's finger 50.

As further illustrated in FIG. 3, visible indicia 58 may be provided for conveying advertisement and/or instruction for use of the card.

The card 24 may have dimensions of about two inches by three inches and be in a rectangular shape which provides dimensions preventing observation of the keypad by another person 62 spaced apart from the user and keypad, as illustrated in FIG. 1. Thus, the card, or shield, 24 prevents undesirable observation of the user's fingertip 36 and the learning of a PIN entered into the keypad 12. The card, or shield, 24 may be made from any suitable materials such as card stock or plastic. If made from plastic, the card 24 may also include a conventional magnetic strip 60 in order that the card 24 may also be used as an ATM, debit, or credit card.

While illustrated in a rectangular shape, it is to also be appreciated that the card 24 may have any shape configurations, such as a disc, or a triangle, or any shape as long as the overall dimensions are suitable for preventing observation of the keypad 12 by another person 62.

A method in accordance with the present invention for enabling secure operation of a keypad 12 is also illustrated in FIGS. 1-2. The method includes providing a security device, or card, 24 to a user 14 of the keypad 12 by way of the holder 28.

Further, the user 14 may be instructed to insert the user's fingertip 36 through a finger opening 32 with such an instruction either being provided on the card 24 by way of the indicia 58 or by way of indicia 72 posted on the ATM machine 74 proximate the keypad 12. The user 14 would also be instructed to position the card 24 relative to the user's finger 50 in order to enable viewing of the keypad 12 by the user 14 and shielding the keypad 12 from the other person 62 spaced apart from the user 14 and the keypad 12.

Although there has been hereinabove described a specific keypad system and method in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A keypad system comprising:
a keypad disposable in a position accessible by a user; and
a supply of security devices disposable proximate said keypad and accessible by the user, each security device including a card having a finger opening sized for receiving a user's fingertip therethrough.

2. The system according to claim 1 further comprising means for temporarily supporting the card on the user's finger proximate the user's fingertip.

3. The system according to claim 2 wherein the means for temporarily supporting the card comprises an iris having radially separatable tabs, with an outer perimeter of the tabs defining the finger opening.

4. The system according to claim 1 further comprising visible indicia disposed on each card for conveying advertisement and/or instruction for use of the card.

5. The system according to claim 3 wherein each card has overall dimensions preventing observation of the keypad by another person spaced apart from the user and the keypad.

6. The system according to claim 1 further comprising radial tabs closing said finger opening and separable by the fingertip for supporting the card on the user's finger.

7. The system according to claim 6 wherein the card has overall dimensions shielding observation of the keypad only by the user.

8. A method for enabling secure operation of a keypad, said method comprising providing a security device to a user of the keypad, said security device including a card having a finger opening therethrough sized for receiving a user's fingertip.

9. The method according to claim 8 further comprising instructing the user to insert the user's fingertip through said finger opening and operate the keypad with the inserted fingertip.

10. The method according to claim 8 further comprising instructing the user to position the card relative to the user's finger in order to enable viewing of the keypad by the user and shielding the keypad from view of another person spaced apart from the user and the keypad.

11. The method according to claim 9 wherein said security device comprises an ATM-type card having a magnetic strip disposed on one side and the method further comprises swiping of the magnetic strip through a card reader.

12. A security shield for use with a keypad, said security shield comprising:
a card having a finger opening sized for receiving a user's fingertip

13. The shield according to claim 12 further comprising radial tabs closing said finger opening and separable by the fingertip for supporting the shield on the user's finger proximate the user's fingertip.

14. The shield according to claim 13 further comprises visible indicia disposed the shield for conveying advertisement and/or instruction for use of the shield.

15. The shield according to claim 14 wherein the shield has overall dimension enabling observation of the keypad only by the user.

16. The shield according to claim 13 wherein said card comprises an ATM-type card having a magnetic strip disposed on one side thereof.

17. The shield according to claim 16 further comprises visible indicia disposed on the shield for conveying advertisement and/or instruction for use of the shield.
